(19) United States
(12) Patent Application Publication
(10) Pub. No.: US 2006/0065755 A1
(43) Pub. Date: Mar. 30, 2006

(54) Atomization method, atomizer based on atomization method, and atomization liquid composition

(75) Inventors: Masaru Sugita, Tokyo (JP); Takeshi Miyazaki, Yokohama-shi (JP); Hideki Kaneko, Kawasaki-shi (JP); Yohei Masada, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/231,782

(22) Filed: Sep. 22, 2005

(30) Foreign Application Priority Data
Sep. 27, 2004 (JP) 2004-279838

(51) Int. Cl. A01G 25/09; A62C 5/02; B05B 7/16; B05B 17/00

(52) U.S. Cl. 239/1; 239/9; 239/128

(57) ABSTRACT

A liquid containing in an aqueous solvent a predetermined concentration of a drug compound used for therapeutic purposes is atomized. The liquid contains a scenting agent and/or a flavoring agent in an aqueous solvent, in addition to the drug compound. Fine droplets of the liquid are ejected through a thermal inkjet system as mist. The scenting agent or the flavoring agent is used for detection of atomization.

### BACKGROUND OF THE INVENTION

1. Field of the Invention

The present invention relates to a method of atomizing and mixing the droplets into air flow by forming fine droplets of a liquid, to an atomizer employing the method and having functions of forming fine droplets of the liquid and atomizing the droplets, and to an atomization liquid composition. In particular, the present invention relates to an atomizer which can be used widely in accordance with a usage pattern of an atomization mechanism used in a medical device of a liquid atomization system such as an inhaler or a nasal inhaler, or in a device for causing predetermined airflow in atmospheric air such as an air conditioner, an air cleaner, an exhaust facility, or an air intake facility.

2. Related Background Art

Examples of many types of devices for causing predetermined airflow in atmospheric air include: devices used in various industrial applications; and devices generally used at home. Examples of various applications include: air supply; air intake; air replacement; air purification; and supply of specific components in a stream of air. For example, an air cleaner is a typical device used for purification of indoor air and successive intake of fresh air to replace the indoor air. Further, an inhaler used for supply of various medicinal components as mist to an affected area of respiratory organ is an example of a device used for supply of specific components in a stream of air.

An atomization mechanism for forming fine droplets of various liquids as mist employs a spray system for forming fine droplets as mist as in a perfume atomizer, for example. The atomization mechanism of a spray system uses a slight pressure difference caused when pressurized air passes through a narrow passage for suction of a liquid through a capillary tube and for mist formation of the liquid, and ejects the liquid as mist. The atomization mechanism of a spray system uses a pressurized gas as a drive force for suction and mist formation of the liquid that has passed through the capillary tube. A pressurized gas is produced by using various devices such as a hand pump and an electric compressor in accordance with the intended use. In a mist formation mechanism of an ultrasonic system, fine air bubbles are formed in a liquid through ultrasonic waves and the fine bubbles are broken on a liquid surface, to thereby cause a recoil force used for discharge of fine droplets. The mist formation mechanism of an ultrasonic system is used in an ultrasonic humidifier, for example. Further examples of a mechanism for forming fine droplets include a mechanism of a vibratory system and a mechanism of a thermal inkjet system, in which an electrically caused fine pressure is applied to a liquid stored in a liquid storage to eject fine droplets from a narrow ejection port. The electrically controlled mechanism of a vibratory system or a thermal inkjet system is used in an inkjet printer head. The electrically driven mechanism for forming fine droplets of a vibratory system or a thermal inkjet system has an advantage in that a trace amount of droplets can be ejected with high accuracy by finely controlling a pressure to be caused. Taking advantage of this point, applications of the mechanism of a vibratory system or a thermal inkjet system have developed in several fields employing a trace amount of droplets, in addition to the inkjet printer head.

Of various atomizers, some atomizers require control of a total amount of a liquid atomized as mist droplets, in addition to control of an amount of individual droplet. For example, a medical inhaler used for supply of various medicinal components as mist to an affected area of respiratory organ, pharynx, or tracheae must be capable of administering desired doses of medicinal components to the affected area. In a case where a desired amount of a liquid containing a specific compound is atomized by using an inhaler, for example, a patient oneself generally uses the inhaler and thus the patient can hardly confirm the atomization through visual observation. To be specific, gas flow associated with the atomization can be detected, but whether a liquid containing a specific compound is actually administered as mist droplets may not necessarily be detected. To be specific, many drug compounds directly administered to an affected area as mist droplets by an inhaler exert desired pharmacological effects through administration of trace amounts thereof. The patient oneself can preferably and actually confirm the atomization of a liquid containing a drug compound for each administration operation, to thereby provide secure administration.

For example, in a case where a drug compound itself, which is administered as mist droplets by an inhaler, has a function of stimulating smell or taste, the drug compound itself can be detected by olfactory cells in a nasal cavity or by taste buds (gustatory organ) in an oral cavity or on a tongue surface. In the case where the drug compound itself has a function of stimulating smell or taste, the drug compound may have unpleasant stimulating taste or smell (such as bitter tastes). Thus, there is proposed a medicinal formulation in the form of a suspension aerosol for a metered-dose inhaler (MDI) in which a masking flavor corrective is added for masking the unpleasant stimulating taste or smell as required and achieving preferable usability (see JP 07-187996 A). For example, a metered-dose inhaler (MDI) of a medicinal formulation in the form of a suspension aerosol uses a liquefied noncombustible or flame-retardant gas as a propellant, and a medicinal formulation containing a drug compound or a masking flavor corrective uniformly suspended in the liquid propellant. A certain amount of the drug compound or the masking flavor corrective together with the liquid propellant is discharged from a narrow nozzle, is atomized while the liquid propellant evaporates, and is dried into fine powder to be administered. Examples of the liquid propellant to be used at this time include noncombustible or flame-retardant gases such as hydrogenated fluorocarbon and partially-hydrogenated fluorocarbon. Fluorine-containing hydrocarbons have significantly smaller adverse effects on health compared to those of various halocarbons. However, the fluorine-containing hydrocarbons may become factors for environmental load and are not ideal propellants.

In the case where a liquefied noncombustible or flame-retardant gas such as hydrogenated fluorocarbon, which is a medium having no solubility, is used as a propellant, a form of a suspension aerosol obtained by suspending fine powder of a drug compound or a masking flavor corrective formed through atomization drying treatment in advance is used. In contrast, in a case where water or ethanol is used as a medium for atomization of mist droplets, a concentrate solution containing a uniformly dissolved or dispersed drug compound or masking flavor corrective must be used.

For example, a coloring compound or flavoring compound used for detection of a concentrate solution used in atomization of a spray system is a hydrophobic compound, and many coloring compounds or flavoring compounds have low solubility in water. The hydrophobic compound having low solubility in water is uniformly dissolved or dispersed in an aqueous solvent to be used by adding a dispersant, a compatibilizer, or the like. In contrast, in a case where no dispersant or compatibilizer is used, the type of coloring compound or flavoring compound that can be used is limited to a compound having solubility to water at a certain level or higher. A hydrophobic drug compound may form an aggregate with a coloring compound or flavoring compound through a hydrophobic interaction and may inhibit uniform dispersion. There is proposed a technique of using a flavor corrective or color as an identification compound for identification of a concentrate solution used in atomization (see U.S. Pat. No. 6,192,882 and U.S. Pat. No. 6,349,719). However, not many devices are made regarding use of a compatibilizer or the like, and the type of flavor or color actually used is limited.

As described above, an inkjet technique is known as a method of forming fine droplets of a liquid sample and ejecting the droplets, and the technique has an advantage regarding an amount of droplets to be ejected in that even a trace amount of the droplets can be controlled. Examples of a known fine droplet ejection method of an inkjet system include: a vibratory system using a piezoelectric element or the like; and a thermal inkjet system using a micro heater element. In the vibratory system using a piezoelectric element or the like, the number of ejection ports provided per unit area is limited in accordance with a limit in size reduction of the piezoelectric element to be used. In particulars the increased number of ejection ports provided per unit area significantly increases a production cost of the vibratory system. Meanwhile, in the thermal inkjet system, size reduction of the micro heater element is relatively easy, and the number of ejection ports provided per unit area may increase compared to that of the vibratory system using a piezoelectric element or the like. Further, a production cost of the thermal inkjet system can be suppressed significantly.

In a case where the thermal inkjet method is applied, physical properties of a liquid to be ejected must be adjusted for adjusting an amount of fine droplets to be ejected from each ejection port and for achieving an appropriate atomized state. That is, devices on liquid composition constituting a liquid sample to be ejected such as the type and composition of solvent and the concentration of solute are made, to thereby allow adjustment for obtaining a target amount of fine droplets.

Further, various technical developments have been made (see JP 2001-161819 A) regarding a droplet ejection mechanism of a thermal inkjet system. There is developed a technique of an atomization mechanism or method of obtaining very fine droplets, in which an amount of individual droplet is in an order of subpicoliter or femtoliter. For example, in a case where a medicinal agent is applied to a somatic cell having a size of several μm, the very fine droplets may have to be used as droplets to be ejected.

### SUMMARY OF THE INVENTION

As described above, various conventional techniques of atomizing a liquid sample are present. Of those, a typical example of a technique which complies with a purpose of controlling a total trace amount of an atomized liquid with high accuracy in each atomization operation such as a medical inhaler is a metered-dose inhaler (MDI) of a suspension aerosol. An atomization amount is controlled by fixing a volume of suspension aerosol to be ejected.

The suspension aerosol ejecting through an atomization capillary contains liquefied gas droplets of a propellant. However, the liquefied gas droplets of the propellant evaporate before the droplets actually reach an affected area, and fine powder obtained through atomization and drying in advance, which is a suspension component, is atomized.

Thus, there is desired means for allowing control of a total amount of fine mist droplets to be atomized in one atomization operation with high accuracy by using no liquefied gas as a propellant and using an atomization liquid prepared by dissolving a drug compound in an aqueous solvent. In particular, on an assumption that the technique is used for a medical inhaler, there is desired a technique employing a mode in which a patient oneself can simply detect predetermined atomization. Further, the technique allows control of a total amount of droplets to be atomized with high accuracy and allows atomization of a liquid prepared by dissolving a drug compound in an aqueous solvent in each atomization operation with high reproducibility.

An object of the present invention is therefore to solve the above-mentioned problems and to provide: a novel atomization method which can be appropriately applied to a medical inhaler, which allows control of a total amount of droplets to be atomized with high accuracy, which allows atomization a liquid prepared by dissolving or uniformly dispersing a drug compound in an aqueous solvent in each atomization operation with high reproducibility, and which employs a mode such that a patient oneself can simply detect predetermined atomization; and an atomizer employing the atomization method.

The inventors of the present invention have conducted intensive studies for achieving the above-mentioned object.

The above-mentioned metered-dose inhaler (MDI) of a suspension aerosol uses a liquefied noncombustible or flame-retardant gas as a propellant and defines a unit volume of the liquefied gas used for one ejection, to thereby allow metered atomization. In atomization of a spray system used for atomization of a liquid employing water or ethanol as a medium, the liquid together with a carrier pressurized gas is discharged through a capillary, to thereby convert the liquid into fine droplets. In principle, an atomization amount can be controlled by defining an amount of the liquid supplied to a capillary passage, but control precision is actually not necessarily high.

In particular, in atomization of a spray system, a pressurized gas used in a process for converting a liquid into fine droplets is also used as gas flow for carrying atomized fine droplets thereafter. Thus, an amount (density) of fine droplets floating in carrier gas flow is hardly changed depending on a purpose because of constitution of the atomization of a spray system.

The inventors of the present invention have searched for means which can be used for converting a liquid into fine droplets. As a result, as disclosed in U.S. Pat. No. 5,894,841, a droplet ejection mechanism of a thermal inkjet system is appropriately used for size reduction of a medical inhaler. The inventors of the present invention have applied the technique disclosed in U.S. Pat. No. 5,894,841, and used a thermal inkjet head having densely arranged ejection ports of fine droplets. Thus, the inventors of the present invention have found atomization means that complies well with applications for allowing setting and control of the total number of fine droplets to be ejected per unit area and per unit time with high accuracy, for controlling a total amount of the droplets to be atomized with high accuracy, and for atomizing the droplets with high reproducibility.

The inventors of the present invention have confirmed that an operation of mixing the atomized fine droplets into the carrier gas flow can be achieved simply by arranging a thermal inkjet head atomizer which can be reduced in size in a tubular passage guiding the carrier gas flow. Note that, in a metered-dose inhaler (MDI) of a suspension aerosol or an atomizer of a spray system, gas flow for carrying atomized fine droplets indicates that the atomized fine droplets are mixed into the gas flow in principle, and there is no need to actually confirm the mixing of the atomized fine droplets. However, in a case where a technique involving independent operations of the atomization operation and the operation of mixing the atomized fine droplets into the carrier gas flow is employed, the mixing must be confirmed. To be specific, in the case where the technique involving independent operations is used for a medical inhaler, inhalation of the atomized liquid is recognized by a subject to be administered with a drug compound, to thereby provide a large mental effect.

The inventors of the present invention have found means for confirming inhalation of the atomized liquid. A scenting agent or a flavoring agent is uniformly mixed into a liquid to be atomized together with a drug compound, and atomized as fine droplets. The atomized fine droplets contain the drug compound, and the scenting agent or the flavoring agent in the mixing ratio, to thereby provide a method allowing control of an atomization amount with high accuracy and allowing detection of mixing of the odor-improvement agent or the flavoring agent by smell or taste. Many flavor correctives that can be used as a scenting agent or a flavoring agent are hydrophobic substances. In present situation, the scenting agent or the flavoring agent used in an aqueous solvent is mostly hydrophilic. For isolation of a hydrophilic substance that can be used as a hydrophilic scenting agent or flavoring agent, an organic solvent extraction method cannot be used in a purification process, and a complex process replacing the organic solvent extraction method is required. Alternatively, synthesis of a hydrophilic substance that can be used as a hydrophilic scenting agent or flavoring agent requires a complex process in isolation and purification processes. Such complex processes often involve high production cost. Meanwhile, use of a hydrophobic substance as a scenting agent or a flavoring agent uniformly mixed into an aqueous solvent allows significant increase in variation of selections of the scenting agent or the flavoring agent in accordance with the use. Most of the hydrophobic substances that can be used as a scenting agent or a flavoring agent can be isolated and purified through an organic solvent extraction method. Further, the hydrophobic substances are commercially available and have advantages in cost. Use of a hydrophobic substance as a scenting agent or a flavoring agent even in a system employing an aqueous medium is useful means from various viewpoints, but some hydrophobic substances are not dispersed uniformly in an aqueous solvent as they are. In such case, the inventors of the present invention have confirmed that a surfactant or a dispersant which can be used for this type of medical inhalation liquid is arbitrarily added to allow uniform dispersion of a hydrophobic substance such as a flavor corrective in an aqueous solvent together with a drug compound. Use of the uniformly-dispersed liquid indicates that the atomized fine droplets contain the drug compound, and the scenting agent or the flavoring agent in the mixing ratio. That is, the inventors of the present invention have verified that a subject to be administered with a drug compound can recognize inhalation of the atomized liquid by detecting the mixed scenting agent or flavoring agent. The inventors of the present invention have completed the atomization method according to the present invention based on the above-mentioned findings.

That is, the present invention relates to an atomization method of atomizing a liquid containing a drug compound in an aqueous solvent, including:

preparing the liquid containing in an aqueous solvent at least one of a hydrophobic scenting agent and a hydrophobic flavoring agent in addition to the drug compound; and

ejecting fine droplets of the liquid as mist through a thermal inkjet system.

In the atomization method according to the present invention, a process for converting a liquid into fine droplets and a process for mixing the atomized fine droplets into carrier gas flow are separate. The process for converting a liquid into fine droplets employs a technique of ejecting the fine droplets of the liquid as mist through a thermal inkjet system. At the same time, the liquid used for atomization contains a scenting agent and/or a flavoring agent in an aqueous solvent, in addition to a drug compound. As a result, atomization means complies well with applications for allowing setting and control of the total number of fine droplets to be ejected per unit time with high accuracy, for controlling a total amount of the droplets to be atomized with high accuracy, and for atomizing the droplets with high reproducibility. In a case where the atomized fine droplets are mixed into the carrier gas flow, the mixed scenting agent and/or flavoring agent serves as an identification mark that can be detected by smell or taste. Thus, application of the above-mentioned technique to a medical inhaler provides a novel atomization method which allows control of a total amount of droplets to be atomized with high accuracy, which allows atomization of a liquid prepared by dissolving a drug compound in an aqueous solvent in each atomization operation with high reproducibility, and which employs a mode such that a patient oneself can simply detect predetermined atomization.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

In the accompanying drawings:

FIG. 1 is a diagram schematically illustrating an example of a structure of an inhaler head cartridge unit according to the present invention;

FIG. 2 is a perspective view showing the external appearance and entire shape of an example of an inhaler according to the present invention; and

FIG. 3 is a perspective view of the example of an inhaler according to the present invention of FIG. 2, showing arrangement of an inhaler head cartridge unit arranged inside an access cover, with the access cover opened.

### DESCRIPTION OF THE PREFERRED EMBODIMENTS

Preferred embodiments of the present invention will now be described in detail in accordance with the accompanying drawings.

Conventionally, in atomization of a spray system widely used for atomization of a liquid employing an aqueous solvent, a pressurized gas used in a process for converting a liquid into fine droplets is also used as gas flow for carrying atomized fine droplets thereafter. Thus, an amount (density) of fine droplets floating in carrier gas flow is hardly changed depending on a purpose because of constitution of the atomization of a spray system.

Meanwhile, an atomization method according to the present invention involves separate processes for converting a liquid into fine droplets and for mixing the atomized fine droplets into carrier gas flow as a technique of avoiding the principle restrictions to the atomization of a spray system.

Basically, an atomization method according to the present invention for atomizing a liquid containing a drug compound includes ejecting fine droplets of the liquid as mist through a thermal inkjet system, in which the liquid contains in an aqueous solvent at least one of a hydrophobic scenting agent and a hydrophobic flavoring agent, in addition to the drug compound. In this case, a commercially available hydrophobic flavoring substance can be used as the hydrophobic scenting agent and/or the hydrophobic flavoring agent. In addition, the liquid desirably contains an additive for uniformly dispersing in the aqueous solvent the drug compound, and at least one of the scenting agent and the flavoring agent.

Further, in the atomization method according to the present invention, the fine droplets to be ejected through a thermal inkjet system are preferably in an amount of subpicoliter or less.

In addition, the present invention provides an atomizer suitable for performing the atomization method according to the present invention. That is, the atomizer according to the present invention used for atomization of a liquid containing a drug compound in an aqueous solvent has a structure of a liquid atomization cartridge including: a reservoir for holding the liquid; a thermal inkjet head capable of ejecting fine droplets of the liquid through a thermal inkjet system; and means for supplying the liquid from the reservoir to the thermal inkjet head.

The atomization method and the atomizer according to the present invention are preferably applied to a medical inhaler, and thus the present invention provides a medical inhaler as an application of the atomization method and the atomizer. That is, according to the present invention, an inhaler for atomizing a liquid containing a predetermined concentration of a drug compound used for therapeutic purposes in an aqueous solvent and allowing a subject to be administered to inhale the atomized liquid includes a structure including: an atomization mechanism for atomizing the liquid by using the atomizer according to the present invention; and an inhalation mechanism attached to the atomization mechanism for allowing the subject to be administered to inhale a gas containing floating fine droplets of the liquid as mist generated by the atomization mechanism.

In a widely used atomizer of a spray system, gas flow for carrying atomized fine droplets indicates that the atomized fine droplets are mixed in the airflow in principle, and there is no need to actually confirm the mixing of the atomized fine droplets. Meanwhile, the atomization method according to the present invention is a technique involving independent operations of the atomization operation and the operation of mixing the atomized fine droplets in the carrier gas flow, and thus the mixing must be confirmed.

In the atomization method according to the present invention, as means for confirming the mixing of the atomized liquid into the carrier gas flow, the scenting agent or the flavoring agent together with the drug compound is mixed into the liquid to be atomized, and the atomized fine droplets contain the drug compound, and the scenting agent or the flavoring agent. As a result, the mixing of the scenting agent or the flavoring agent can be detected by smell or taste, and the detection can be used for confirmation of atomization of the liquid and mixing of the liquid into the carrier gas flow thereafter.

In the atomization method according to the present invention, a liquid used as an atomization liquid contains in an aqueous solvent a predetermined concentration of a drug compound used for therapeutic purposes. The liquid further preferably contains a scenting agent and/or a flavoring agent uniformly dispersed in an aqueous solvent, in addition to the drug compound. The drug compound and a flavor corrective used as a flavoring agent or a scenting agent may be hydrophobic substances having poor solubility in an aqueous solvent, in addition to hydrophilic substances which can be dissolved uniformly in the aqueous solvent. However, a surfactant or a dispersant that can be used for a medical inhalation liquid is arbitrarily added to allow uniform dispersion of hydrophobic substances mixed as the drug compound, and the flavoring agent or the scenting agent. Selection of the liquid composition achieving uniform dispersion in an aqueous liquid indicates that the atomized fine droplets contain the drug compound, and the scenting agent and/or the flavoring agent in the same mixing ratio as that of the liquid used as an atomization liquid.

Hereinafter, the present invention will be described in more detail.

An atomization liquid to be used for the atomization method according to the present invention contains a drug compound in an aqueous solvent. An example of the drug compound is a pharmaceutical compound for various therapeutic purposes administered in a form of an atomization liquid. Examples of a drug compound generally used as a pharmaceutical compound providing useful pharmacological and physiological actions for various therapeutic purposes include an anti-inflammatory steroid, a nonsteroidal anti-inflammatory drug, a depressant, a depression therapeutic drug, an analgesic, an asthma medicine, a β-sympathetic agent, an anticholinergic agent, a mast cell stabilizer, an antagonist, an antitussive agent, an expectorant, an antihistamine, an antiallergic drug, an antiemetic drug, a sleep inducing drug, vitamins, sex steroid hormones, an antitumor drug, an antiarrhythmic agent, an antihypertensive drug, an antianxiety agent, an antipsychotic agent, a cardiac stimulant, a bronchodilator, an obesity drug, an antimigraine agent, an antirheumatic drug, a protein formulation, hormones, cytokines, a receptor, an antibody, an enzyme, a vaccine, a virus, an antisense, a gene, and nucleic acids.

Specific examples of a drug compound that can be used by being incorporated in an aqueous solvent include hydrocortisone, prednisolone, triamcinolone, dexamethasone, betamethasone, beclomethasone, fluticasone, mometasone, fluocortin, budesonide, salbutamol, salmeterol, acetoaminophenone, phenacetin, nedocromil, aspirin, aminopyrine, sulpyrine, phenylbutazone, mefenamic acid, flufenamic acid, ibufenac, ibuprofen, alclofenac, diclofenac, indometacin, scopolamine, imipramine, disodium cromoglycate, codeine phosphate, isoproterenol hydrochloride, diphenhydramine, triprolidine, isothipendyl, chlorpheniramine, amlexanox, azelastine, ozagrel, tranilast, ketotifen, ondansetron, granisetron, metoclopramide, cisapride, domperidone, brotizolam, melatonin, cyanocobalamin, mecobalamin, estradiol, estriol, progesterone, testosterone, tamoxifen, tegafur, propranolol, atenolol, nicardipine, diazepam, nitrazepam, dopamine, morphine, buprenorphine, oxitropium, mazindol, beraprost, acarbose, sorbinil, pinaverium, inaperisone, ergotamine, imigran, actarit, and platonin.

Examples of proteins used for medical applications include insulins, growth hormones, growth hormone releasing factors, luteinizing hormone-releasing hormones, somatostatin derivatives, vasopressins, follicle stimulating hormones, gonadotropic hormones, luteinizing hormones, adrenocorticotrophic hormones, parathyroid hormones, thyroid stimulating hormones, antihypertensive peptides, hypertensive peptides, glucagons, G-CSF, GM-CSF, M-CSF, CSF, GLP-1, erithropoietin, interferon, interleukin, calcitonin, and cell adsorption proteins. Researches described in Critical Reviews in Therapeutic Drug Carrier Systems, 12 (2&3) (1995) have revealed that the proteins providing various pharmacological actions exemplified above are delivered to lung, permeate through endothelial lung tissues of the lung, and are incorporated into blood flow of a capillary vessel, for example.

A content (mass concentration) of the drug compound in the atomization liquid is preferably selected in the range of 1 ppm to 10%, and more preferably in the range of 0.001% to 5% in an aqueous solvent.

The atomization liquid to be used for the atomization method according to the present invention contains the scenting agent or the flavoring agent in the aqueous solvent, in addition to the drug compound. Examples of a substance which serves as a scenting agent or a flavoring agent when mixed into an atomization liquid include various natural flavor correctives, synthetic flavor correctives, and prepared flavor correctives, and general flavoring components used in cosmetic fragrances, soap fragrances, food flavors, and the like. Of those, a scenting agent acts when its evaporated compound molecules reach into a nasal cavity and are recognized by olfactory receptor cells. In contrast, a flavoring agent acts when it reaches into an oral cavity and is recognized by a gustatory organ (taste buds) on a tongue. The scenting agent or the flavoring agent used in combination with the drug compound is used when atomization itself is hardly confirmed by other perception such as visual observation. The scenting agent or the flavoring agent is used for confirmation of atomization through detection of a trace amount of the scenting agent or flavoring agent in fine droplets to be atomized by smell or taste. In addition, in a case where the drug compound provides an action of stimulating smell or taste, the scenting agent or the flavoring agent to be used in combination with the drug compound may have a function of effectively masking stimulus caused by the drug compound. Technical scope of the present invention includes use of the scenting agent or the flavoring agent in combination with the drug compound even when atomization can be recognized by stimulus of the drug compound to smell or taste such as a case in which a so-called “bitter” taste of a drug compound is masked by taste of another flavoring agent, as long as stimulus of a scenting agent or a flavoring agent to smell or taste can be used for detection of atomization.

Specific examples of a natural flavor corrective that can be used as a scenting agent or a flavoring agent include musk, civet, castor, ambergris, lemon oil, petitgrain oil, neroli oil, orange oil, bergamot oil, rose oil, lemon grass oil, ginger glass oil, citronella oil, palmarosa oil, vetiver oil, sandalwood oil, linaloe oil, opopanax oil, rosemary oil, thyme oil, peppermint oil, lavender oil, clary sage oil, perilla oil, spike oil, patchouli oil, geranium oil, ajowan oil, anise oil, caraway oil, coriander oil, fennel oil, jasmine oil, bois de rose oil, cinnamon oil, cassia oil, bay oil, clove oil, cajeput oil, ylang-ylang oil, cananga oil, cedarwood oil, abies oil, star anise oil, tuberose oil, orris oil, oak moss oil, camphor oil, turpentine oil, and coconut oil. Isolated substances of various flavoring components in the natural flavor corrective can be used as a scenting agent or a flavoring agent.

Examples of a synthetic flavor corrective (flavoring component) that can be used as a scenting agent or a flavoring agent include α-pinene, β-pinene, camphene, limonen, dipentene, terpinolene, myrcene, p-cymene, β-caryophyllene, cis-3-hexenol, linalol, geraniol, nerol, citronellol, rhodinol, dimethyloctanol, hydroxycitronellol, tetrahydrolinalol, lavandulol, myrcenol, α-terpineol, borneol, isopulegol, nopol, farnesol, nerolidol, santalol, cedrol, vetiverol, γ-phenylpropylalcohol, cinnamic alcohol, dimethylbenzylcarbinol, methylphenylcarbinol, dimethylphenylcarbinol, β-phenylethyldimethylcarbinol, β-phenylethylmethylethylcarbinol, phenyl glycol, tert-butylcyclohexanol, n-heptylaldehyde, n-octylaldehyde, n-nonylaldehyde, n-decylaldehyde, n-undecylaldehyde, undecylenic aldehyde, dodecylaldehyde, methylnonylacetaldehyde, n-tridecylaldehyde, n-tetradecylaldehyde, n-hexadecylaldehyde, 2,6-nonadienal, citral, citronellal, hydroxycitronellal, perillaldehyde, phenylacetaldehyde, phenylpropylaldehyde, p-tolylaldehyde, p-tolylacetaldehyde, cinnamic aldehyde, α-amylcinnamic aldehyde, a-hexyicinnamic aldehyde, cumine aldehyde, cyclamen aldehyde, p-tert-butyl-α-methylhydroxycinnamic aldehyde, salicylic aldehyde, γ-undecalactone, ethyl methylphenylglycidate, γ-nonyllactone, ethyl p-methyl-β-phenylglycidate, allyl caproate, allyl caprylate, 4-(4-hydroxy-4-methylpentyl)-3-cyclohexene-1-carboxyaldehyde, citronellyloxyacetaldehyde, citral dimethyl acetal, citral diethyl acetal, phenylacetaldehyde dimethylacetal, ethyl-n-amylketone, methyl-n-hexylketone, methyl-n-nonylketone, methylheptenone, 1-carvone, menthone, d-pulegone, piperitone, acetophenone, p-methylacetophenbne, p-methoxyacetophenone, benzophenone, benzylidene acetone, methyl naphthyl ketone, a-ionone, β-ionone, methyl ionone, irone, nerone, anisyl acetone, cis-jasmone, dihydrojasmone, nootkatone, muscon, civetone, cyclopentadecane, cyclopentadecanolide, ambrettolide, cyclohexadecanolide, ethylene brassylate, 12-oxahexadecanolide, 11-oxahexadecanolide, 10-oxahexadecanolide, musk xylene, musk ketone, musk ambrette, musk tibetene, moskene, phantolide, celestolide, versalide, tonalide, galaxolide, anisol, p-acetylanisol, diphenyloxide, dimethylhydroquinone, p-cresol methyl ether, anethole, dihydroanethole, carvacrol, eugenol, isoeugenol, methyl eugenol, methyl isoeugenol, benzyl isoeugenol, safrole, isosafrole, β-naphthol methyl ether, β-naphthol ethyl ether, vanitrope, geranyl formate, benzyl formate, phenylethyl formate, citronellyl acetate, geranyl acetate, linalyl acetate, menthyl acetate, bornyl acetate, terpinyl acetate, benzyl acetate, phenylethyl acetate, cinnamyl acetate, methylphenylcarbinyl acetate, anisyl acetate, paracresyl acetate, isoeugenol acetate, myrcenyl acetate, cedryl acetate, tert-butylcyclohexyl acetate, dihydroterpinyl acetate, ethyl propionate, citronellyl propionate, linalyl propionate, geranyl propionate, terpinyl propionate, benzyl propionate, cinnamyl propionate, isoamyl butyrate, geranyl butyrate, linalyl butyrate, linalyl isobutyrate, citronellyl butyrate, citronellyl isobutyrate, benzyl butyrate, benzyl isobutyrate, n-propyl isovalerate, isoamyl isovalerate, geranyl isovalerate, cinnamyl isovalerate, ethyl caproate, isoamyl caproate, citronellyl caproate, ethyl caprylate, methyl heptynecarboxylate, ethyl heptynecarboxylate, methyl octynecarboxylate, ethyl. pyruvate, methyl β-methylpropionate, ethyl benzoate, isobutyl benzoate, isoamyl benzoate, geranyl benzoate, linalyl benzoate, benzyl benzoate, phenylethyl benzoate, methyl phenylacetate, ethyl phenylacetate, isobutyl phenylacetate, isoamyl phenylacetate, geranyl phenylacetate, benzyl phenylacetate, methyl cinnamate,. ethyl cinnamate, benzyl cinnamate, cinnamyl cinnamate, diethyl phthalate, ethyl salicylate, isobutyl salicylate, isoamyl salicylate, benzyl salicylate, phenylethyl salicylate, methyl anisate, ethyl anisate, methyl anthranate, ethyl anthranate, methyl methylanthranate, methyl jasmonate, methyl dihydrojasmonate, rose oxide, oxide ketone, linalol oxide, bicyclodihydrohomofarnesyl oxide, indole, skatole, 6-methylquinoline, 6-methyltetrahydroquinoline, 7-methylquinoline, 6-isopropylquinoline, isobutylquinoline, bromostyrol, trichloroacetate methylphenylcarbinyl, and furfuryl mercaptan.

A mixing ratio of the flavor corrective or the like mixed as a flavoring agent or a scenting agent into an atomization liquid used for the atomization method according to the present invention varies depending on the type of flavor corrective to be used, but is set in the range of generally 1 ppb to 10%, and more preferably in the range of 1 ppm to 1%. Further, the flavoring agent and the scenting agent may be used in combination without inhibiting the intended use of the atomization liquid. That is, for administration into a nasal cavity, a flavoring agent providing no adverse effects on tissues of the nasal cavity to be administered may be added to a scenting agent for use. Alternatively, for administration into pharynx or tracheae through an oral cavity, a scenting agent providing no adverse effects on inner wall tissues of the pharynx or tracheae to be administered may be added to a flavoring agent for use.

Thus, the atomization liquid contains at least one flavoring substance exemplified above as a flavoring agent or a scenting agent, and may contain a plurality of types of flavoring substances.

The drug compound mixed into the atomization liquid used for the atomization method according to the present invention or the flavor corrective used as a flavoring agent or a scenting agent may be a hydrophobic substance not exhibiting desired solubility in an aqueous solvent. In this case, a dispersant, a surfactant, or the like that can be used for achieving uniform dispersion of the hydrophobic substance may be added as required. In addition, appropriate amounts of various additives that comply with the intended use of the atomization liquid such as a dispersant, a surfactant, a surface modifier, a viscosity modifier, a solvent, a humectant, and a pH adjuster may be used.

Specific examples of the additives that may be mixed include an ionic surfactant, a nonionic surfactant, an emulsifier, a dispersant, a hydrophilic binder, a hydrophobic binder, a hydrophilic thickener, a hydrophobic thickener, glycerine, glycols, glycol derivatives, alcohols, urea, an electrolyte, and a buffer component. One type of additive may be added or a plurality of types of additives may be added as required.

Various substances used as the additives as exemplified above are more preferably those used for medical applications described in phamacopoeia of each country as minor constituents that can be added in preparation of a therapeutic liquid or those allowed in food or cosmetics.

An addition ratio (mass concentration) of each substance mixed as the additive differs depending on the drug compound as the intended main component, and the type of flavor corrective used as a flavoring agent or a scenting agent and the mixing ratio thereof, but is selected in the range of preferably 0.01% to 40%, more preferably 0.1% to 20%. Meanwhile, an addition amount of the additive varies depending on the use (function), type, and combination of the additives, but is preferably selected in the range of 0.5 part by mass to 100 parts by mass with respect to a total amount of the drug compound, which is an essential component of the liquid, and the scenting agent or the flavoring agent as 1 part by mass from the viewpoint of ejection property of the liquid to be mixed.

In the atomization method according to the present invention, atomization of the liquid involves ejection of fine droplets of the liquid as mist through a thermal inkjet system. The fine droplets of the liquid ejected through the thermal inkjet system transiently floats in gas flow as mist, and the droplets each preferably have a size of 30 μm or less. Thus, a liquid ejection apparatus of a thermal inkjet system capable of ejecting fine droplets having an average droplet size in the range of 1 μm to 25 μm is preferably used. In the atomization method, when a subject to be administered inhales an atomized liquid containing the drug compound for therapeutic purposes, the liquid in an amount satisfying a sufficient dose of the drug compound required for target therapeutic effects can be administered in a form of mist.

To be specific, in a case where a droplet ejection mechanism of a thermal inkjet system is used, a thermal inkjet head can be used. The thermal inkjet head has liquid ejection units with reduced size and ejection ports of fine droplets arranged at high density per unit area. In this case, the individual ejection unit may have highly accurate and highly reproducible size of an ejection port, amount of heat pulse used for ejection, size of a micro heater, and the like. A narrow droplet size distribution can be achieved across many liquid ejection units arranged at high density on the head. The atomization method according to the present invention preferably employs a thermal inkjet head produced with high size accuracy and high reproducibility and having ejection ports of fine droplets arranged at high density per unit area.

In the atomizer according to the present invention, a thermal inkjet head part capable of ejecting fine droplets of the liquid through a thermal inkjet system preferably has a structure allowing independent drive of many liquid ejection units forming the thermal inkjet head part. In this case, the atomizer preferably includes a liquid atomization cartridge in which: an electrical connection part required for independent drive of each liquid ejection unit for connecting plurality of control signals and the like, and a wiring connecting the liquid ejection units are formed integrally; and a reservoir holding the liquid, and a liquid passage as means for supplying the liquid from the reservoir to the thermal inkjet head are formed integrally.

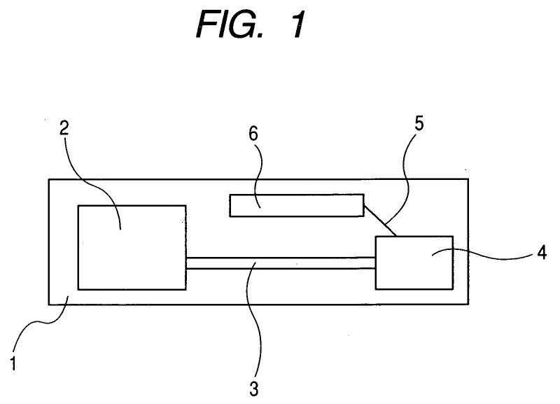

FIG. 1 schematically shows an example of an entire structure of a liquid atomization cartridge. The cartridge shown in FIG. 1 is produced by integrally arranging a head part 4 for atomizing a liquid, a reservoir 2 to be filled with the liquid, and a liquid passage 3 for guiding the liquid from the reservoir 2 to the head part 4 on a substrate 1. A controller for controlling drive of each liquid ejection unit of the head part 4 exchanges drive signals, control signals, and the like with the head part 4 through an electrical connection part 6 connected with an internal wiring 5.

In this case, the head part 4 preferably employs an ejection head for very fine droplets disclosed in JP 2003-154655 A which is capable of controlling an amount of each fine droplet to be ejected in an order of subpicoliter or femtoliter, and which has excellent controllability.

In the case shown in FIG. 1, one type of liquid is atomized, and one reservoir 2 to be filled with the liquid is used. In FIG. 1, reference numeral 1 represents a substrate, reference numeral 3 represents a liquid passage, and reference numeral 4 represents a head part. Further, reference numeral 5 represents a wiring, and reference numeral 6 represents an electrical connection part with an apparatus main body. In a case where two or more types of liquids are atomized, a plurality of reservoirs filled with corresponding liquids may be provided arbitrarily, and a thermal inkjet head may have an integrated structure with plural liquid ejection units.

An inhaler according to the present invention makes full use of an advantage of separate processes for converting a liquid into fine droplets and for mixing the atomized fine droplets into carrier gas flow, which is a feature of the atomization method according to the present invention. That is, in a case where a liquid containing in an aqueous solvent a predetermined concentration of a drug compound used for therapeutic purposes is atomized and a subject to be administered inhales the atomized liquid, an amount (dose per single administration) of the drug compound in a gas to be inhaled can be arbitrarily set. In this case, a thermal inkjet head having ejection ports of fine droplets arranged at high density per unit area is used as an atomization mechanism for atomizing the liquid allowing size reduction of the atomizer for portable use.

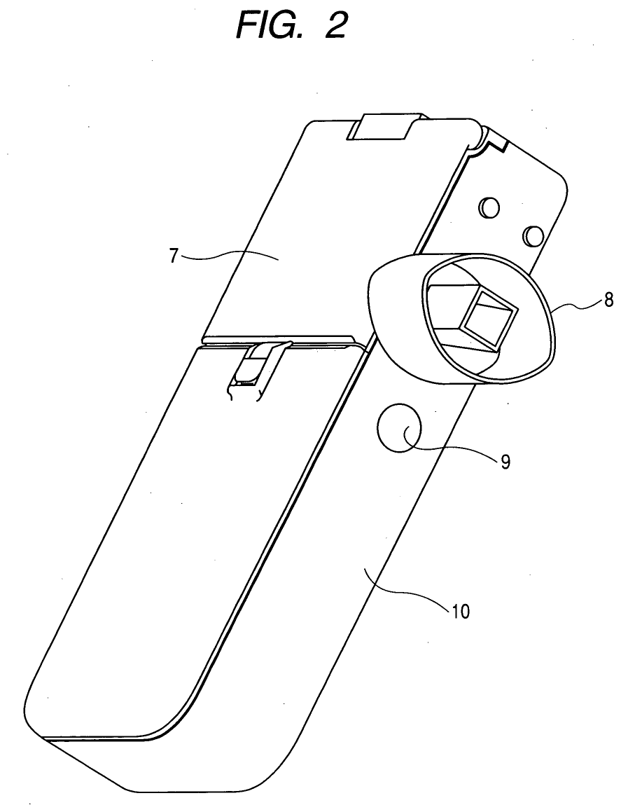

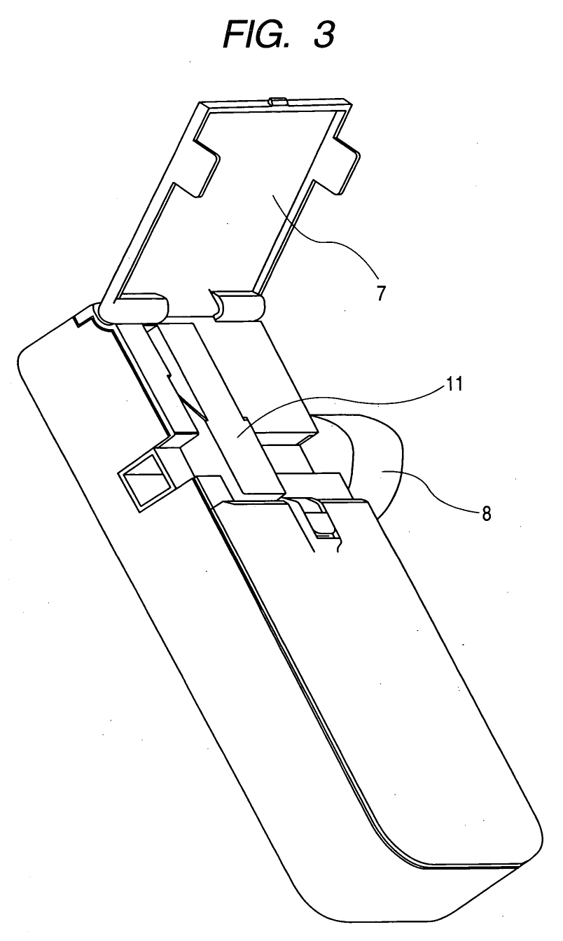

FIGS. 2 and 3 each show a structure of an example of a medical inhaler which is reduced in size for portable use. FIG. 2 is a perspective view showing an external appearance of the inhaler. An inhaler main body 10 is provided with: a housing for holding a liquid atomization cartridge, its controller, a power source (battery) and the like; and a mouth piece 8 brought to a mouth during inhalation. Reference numeral 9 represents a power button. The liquid atomization cartridge is integrally formed with a liquid reservoir as shown in FIG. 1, and it can be replaced by opening an access cover 7. FIG. 3 is a view showing the inhaler with the access cover opened, and a head cartridge unit 11 is provided in a tubular air passage guiding air from an air intake port into the mouth piece 8. In a head part of the head cartridge unit 11, a liquid formed into fine droplets through a thermal inkjet system and atomized is mixed into airflow in the tubular air passage. The inhaler employs a system in which a user holds the mouth piece 8 in one's mouth and inhales, to thereby allow flow of air from an air intake port. That is, the structure of the air intake part corresponds to an inhalation mechanism allowing a subject to be administered to inhale a gas floating fine droplets of a liquid as mist generated by the atomization mechanism.

The structure shown in FIG. 3 is employed, to thereby allow fine droplets of a liquid to be atomized to naturally reach into pharynx or trachea of a subject to be administered through inhalation. Thus, an amount (dose) of the liquid to be atomized does not vary depending on a volume of air inhaled, and is independently controlled. To be specific, a head part of the head cartridge unit 11 has a structure employing a very fine droplet ejection head disclosed in JP 2003-154655 A and producing fine droplets having an average droplet size of about 3 μm.

In a case where fine droplets having an average droplet size in the range of 1 μm to 25 μm are ejected, a flavor corrective in the fine droplets evaporates easily to impart aroma derived from the flavor corrective used. In the inhaler shown in FIG. 2, very fine droplets of a liquid to be atomized are directly guided into an oral cavity through inhalation, and the generated aroma derived from the flavor corrective sufficiently stimulates olfactory cells and is detected as a scenting agent.

Hereinafter, the present invention will be described in more detail by way of examples. The examples represent best modes for carrying out the present invention, but the present invention is not limited to the modes shown by examples.

### EXAMPLES

The following verification tests confirmed effectiveness of an atomization method according to the present invention.

<Preparation of Atomization Liquid Sample for Testing>

A drug compound, a flavor corrective such as a scenting agent or a flavoring agent, and an additive such as a surfactant were added, and the mixture was uniformly stirred in a sample bottle, to thereby prepare a mixed liquid as an atomization liquid sample used for a verification test. Table 1 shows compositions of the prepared atomization liquid samples.

Note that, an atomization liquid sample 1 contained no flavor corrective used as a scenting agent or a flavoring agent, and atomization liquid samples 3 and 7 each contained no surfactant component added for accelerating dispersion of the flavor corrective used as a scenting agent or a flavoring agent.

TABLE 1
Composition of atomization liquid sample

| | | Scenting | | |
|---|---|---|---|---|
| | | agent/ | | |
| Atomization | | flavoring | | |
| liquid | Drug | agent | | Purified |
| sample | compound | (flavor) | Additive | water |
| 1 | Salbutamol: 1% | — | Polysorbate | 98% |
| | | | 80: 1% | |
| 2 | Salbutamol: 1% | Peppermint | Polysorbate | 97.9% |
| | | oil: 0.1% | 80: 1% | |
| 3 | Salbutamol: 1% | Peppermint | — | 98.9% |
| | | oil: 0.1% | | |
| 4 | Salbutamol: 1% | Rose oil: | Polyoxyl 40 | 95% |
| | | 2% | stearate: 1% | |
| | | | Glycerin: 1% | |
| 5 | Salbutamol: 1% | Lemon oil: | Polysorbate | 96% |
| | | 1% | 20: 1% | |
| | | | Isopropyl | |
| | | | alcohol: 1% | |
| 6 | Insulin: 0.1% | Limonene: | Polysorbate | 97.89% |
| | | 0.01% | 20: 1% | |
| | | | Cresol: 1% | |
| 7 | Insulin: 0.1% | Limonene: | Cresol: 1% | 97.89% |
| | | 0.01% | | |
| 8 | Insulin: 0.1% | Peppermint | Polysorbate | 97.8% |
| | | oil: 0.1% | 20: 1% | |
| | | | Cresol: 1% | |
| 9 | Insulin: 0.5% | Peppermint | Polysorbate | 97% |
| | | oil: 0.5% | 20: 1% | |
| | | | Cresol: 1% | |

<Atomizer>

The examples employ the following atomizers of two thermal inkjet systems for atomization of the atomization liquid sample for testing.

System 1: An atomizer which employs a bubble jet printer head part used in a bubble jet printer PIXUS 950i (manufactured by Canon Inc.) and which is capable of supplying an atomization liquid sample using an aqueous solvent to an ink supply part of the printer head through a silicone tube.

System 2: An atomizer for inhaler which applies a droplet ejection head of a thermal inkjet system capable of ejecting a very fine amount (subpicoliter) of droplets disclosed in JP 2003-154655 A described above. Operation conditions include: a frequency of 20 kHz; a voltage of 12 V; and an ejection cycle of ejection for 1 second and interval of 3 seconds.

The very fine droplet ejection head of a thermal inkjet system is capable of ejecting fine droplets of aqueous ink having a diameter of 3 μm, which corresponds to an amount of fine droplets of about 0.02 picoliter.

<Evaluation Method>

(1) Evaluation of Aroma Derived from Scenting Agent/Flavoring Agent (Flavor Corrective) in Fine Droplets of Liquid to be Atomized

In atomization of the fine droplets by the atomizer under the same conditions, the aroma derived from the flavor corrective detected in an atmosphere was evaluated through sensory testing when a total amount of a liquid to be atomized reached a predetermined amount.

A predetermined amount of the atomization liquid sample to be atomized itself was dropped onto filter paper, and the aroma derived from the flavor corrective and generated from the paper was defined as “positive control”, which was compared with the aroma detected in an atmosphere after atomization of the sample. Evaluation standards are classified into three categories.

A: Compared with “positive control”, “aroma” derived from flavor corrective in atomization was not different from that of the positive control, and the “aroma” had a desired strength.

B: Compared with “positive control”, “aroma” derived from flavor corrective in atomization was detected, but the “aroma” had significantly lower strength than the desired strength.

C: Compared with “positive control”, “aroma” derived from flavor corrective in atomization was substantially not detected.

Note that, the atomization liquid sample 1 contained no flavor corrective to be used as a scenting agent or a flavoring agent, and was evaluated as “C”.

(2) Droplet Size of Fine Droplets to be Atomized

In atomization of the fine droplets by the atomizer under the same conditions, an average size of droplets to be atomized is determined through a laser diffusion method, assuming that each droplet has a shape of a spherical particle.

(3) Amount of Drug Compound in Fine Droplets to be Atomized

In atomization of the fine droplets by the atomizer under the same conditions, the total amount of the droplets to be atomized was collected, and an amount of the drug compound therein “atomized amount of drug compound” was evaluated. Meanwhile, an “initial amount of drug compound” was calculated from the composition of the atomization liquid sample based on the amount of the atomization liquid sample used for atomization, and a ratio (amount ratio) of “atomized amount of drug compound”/“initial amount of drug compound” was used as an evaluation index.

In a case where the drug compound was a chemical substance, the “atomized amount of drug compound” was measured by: using the total amount of droplets to be atomized and collected; and using absorption characteristic to the chemical substance. In a case where the drug compound was a substance except a chemical substance such as a peptide, a protein, nucleic acids, or a virus, a known method used for its quantitative determination was used.

To be specific, a total amount of droplets to be atomized and collected and an appropriate liquid medium for a quantitative determination operation were used, to thereby prepare a quantitative sample in a predetermined amount. The quantitative sample was measured for concentration of the drug compound therein and amount of collected drug compound through one of two quantitative determination methods described below.

Method 1: An absorbance of the quantitative sample was measured by using a commercially available UV-vis spectrophotometer (V-560, manufactured by JASCO Corporation) for absorption characteristic to the drug compound to be measured. The concentration of the drug compound in the quantitative sample was determined from its absorbance based on a calibration curve of concentration and absorbance of the medicinal.

Method 2: A concentration of the drug compound in the quantitative sample was determined through a known method used for quantitative determination of the drug compound to be measured such as a quantitative method using an immune reaction or an antigen-antibody reaction.

Table 2 collectively shows the results of evaluation regarding the three items described above.

TABLE 2

| | | | | | | Atomized amount | |
|---|---|---|---|---|---|---|---|
| | | Droplets to be | | | | of drug | |
| | Atomization | atomized | | | | compound | |
| | liquid | | Droplet | | | | Amount |
| | sample | System | size | | “Aroma” | Method | ratio |
| Example 1 | 2 | 1 | 20 | μm | A | 1 | 1.00 |
| Example 2 | 2 | 1 | 20 | μm | A | 1 | 1.00 |
| Example 3 | 2 | 2 | 3.2 | μm | A | 1 | 0.99 |
| Example 4 | 4 | 2 | 3.1 | μm | A | 1 | 0.98 |
| Example 5 | 5 | 2 | 3.5 | μm | A | 1 | 0.99 |
| Example 6 | 6 | 1 | 19 | μm | A | 2 | 0.99 |
| Example 7 | 6 | 2 | 3.4 | μm | A | 2 | 0.96 |
| Example 8 | 8 | 1 | 20 | μm | A | 2 | 0.98 |
| Example 9 | 8 | 2 | 3.3 | μm | A | 2 | 0.95 |
| Example 10 | 9 | 1 | 21 | μm | A | 2 | 0.98 |
| Example 11 | 9 | 2 | 3.3 | μm | A | 2 | 0.96 |
| Comparative | 1 | 1 | 20 | μm | C | 1 | 1.00 |
| Example 1 | | | | | | | |
| Comparative | 3 | 1 | 20 | μm | C | 1 | 0.05 |
| Example 2 | | | | | | | |
| Comparative | 7 | 1 | 20 | μm | C | 2 | 0.27 |
| Example 3 | | | | | | | |

The results shown in Table 2 reveal that the atomization liquid samples 2, 4 to 6, 8, and 9, in which a surfactant was added to uniformly disperse the hydrophobic flavor corrective mixed as a scenting agent/flavoring agent, contained uniformly the flavor corrective and the drug compound in the fine droplets to be atomized. Thus, in the atomization liquid samples 2, 4 to 6, 8, and 9, the “aroma” derived from the flavor corrective was actually detected sufficiently in atomization. That is, the tests verified that the presence or absence of the “aroma” derived from the flavor corrective mixed as a scenting agent/flavoring agent can confirm whether or not appropriate atomization was performed.

Meanwhile, an average droplet size of the fine droplets to be atomized was about 20 μm or about 3 μm, which corresponds to a “designed average droplet size” of each atomizer employing a droplet ejection head of a thermal inkjet system. In a case where the drug compound and the hydrophobic flavor corrective as a scenting agent/flavoring agent were mixed into an aqueous solvent, a surfactant was added for uniformly dispersing the flavor corrective into the aqueous medium. Thus, the resulting atomization liquid containing uniformly dispersed flavor corrective and drug compound verified that highly accurate controllability and reproducibility of the average droplet size of the fine droplets can be achieved.

The following experiment verified that a total amount of the fine droplets to be atomized can be determined by setting an atomization time at higher linearity owing to highly accurate controllability and reproducibility of the average droplet size.

The atomization was performed under the same conditions, and an atomization time was changed. A total amount of the droplets to be atomized during the atomization time is collected, to thereby compare a “collected amount of drug compound” and the atomization time.

TABLE 3

| | | | | Collected |
|---|---|---|---|---|
| | Atomization | Atomizer | | amount of |
| | liquid | | Atomization | drug |
| | sample | System | time | compound |
| Example 12 | 2 | 1 | 60 seconds | 1.2 g |
| Example 13 | 2 | 1 | 120 seconds | 2.4 g |
| Example 14 | 2 | 1 | 180 seconds | 3.5 g |

The results of Table 3 confirm that when the total amount of the droplets to be atomized was collected, an amount of the drug compound “collected amount of drug compound” collected at the same time was proportional to the atomization time, and that the total amount of the drug compound to be administered can be determined with high accuracy by setting the atomization time.

The atomization method according to the present invention allows control of a total amount of droplets to be atomized with high accuracy and allows atomization a liquid prepared by dissolving a drug compound in an aqueous solvent in each atomization operation with high reproducibility. At the same time, the atomization method according to the present invention employs a mode allowing simple detection of predetermined atomization by a patient oneself. In particular, the atomization method may be applied to a medical inhaler for significant value. In addition, the atomization method according to the present invention has advantages in that a total amount of droplets to be atomized can be controlled with high accuracy per unit time and that setting of the total amount of the droplets can be changed arbitrarily and easily. That is, the atomization method according to the present invention is a technique that can be used for various applications of liquid atomization in various industrial fields which require determination of the total amount of the atomized droplets to be mixed, independent of the amount of gas flow.

The present invention is not limited to the above embodiments and various changes and modifications can be made within the spirit and scope of the present invention. Therefore to apprise the public of the scope of the present invention, the following claims are made.

This application claims priority from Japanese Patent Application No. 2004-279838 filed on Sep. 27, 2004, which is hereby incorporated by reference herein.

What is claimed is:

1. An atomization method of atomizing a liquid containing a drug compound in an aqueous solvent, comprising:
preparing the liquid containing in an aqueous solvent at least one of a hydrophobic scenting agent and a hydrophobic flavoring agent in addition to the drug compound; and
ejecting fine droplets of the liquid as mist through a thermal inkjet system.

2. An atomization method according to claim 1, wherein the liquid contains an additive for uniformly dispersing in the aqueous solvent the drug compound, and at least one of the scenting agent and the flavoring agent.

3. An atomization method according to claim 1, wherein fine droplets to be ejected through a thermal inkjet system are in amount of subpicoliter or less.

4. An atomizer which employs the atomization method according to claim 1 and which can be used for atomization of a liquid containing a drug compound in an aqueous solvent, the atomizer having a structure of a liquid atomization cartridge including:
a reservoir for holding the liquid;
a thermal inkjet head capable of ejecting fine droplets of the liquid through a thermal inkjet system; and
means for supplying the liquid from the reservoir to the thermal inkjet head.

5. An inhaler for atomizing a liquid containing a drug compound in an aqueous solvent and allowing a subject to be administered to inhale the atomized liquid, the inhaler having a structure including:
an atomization mechanism for atomizing the liquid by using the atomizer according to claim 4; and
an inhalation mechanism attached to the atomization mechanism for allowing the subject to be administered to inhale a gas containing floating fine droplets of the liquid as mist generated by the atomization mechanism.

6. An atomization liquid composition containing a drug compound used for ejecting fine droplets of a liquid as mist through a thermal inkjet system, comprising in an aqueous solvent at least one of a hydrophobic scenting agent and a hydrophobic flavoring agent, in addition to the drug compound.

7. A composition according to claim 6, wherein the liquid contains an additive for uniformly dispersing in the aqueous solvent the drug compound, and at least one of the scenting agent and the flavoring agent.

8. A composition according to claim 6, wherein the fine droplets to be ejected through a thermal inkjet system are in amount of subpicoliter or less.

9. A medicinal inhalation composition comprising the composition according to claim 6, wherein:
the drug compound is a drug compound used for therapeutic purposes; and
a gas containing floating fine droplets of the composition as mist is inhaled by a subject to be administered.
